(19) United States
(12) Patent Application Publication
(10) Pub. No.: US 2022/0147023 A1
(43) Pub. Date: May 12, 2022

(54) METHOD AND DEVICE FOR IDENTIFYING INDUSTRY CLASSIFICATION OF ENTERPRISE AND PARTICULAR POLLUTANTS OF ENTERPRISE

(71) Applicant: Chinese Academy of Environmental Planning, Beijing (CN)

(72) Inventors: Xiahui WANG, Beijing (CN); Guoxin HUANG, Beijing (CN); Shouxin ZHU, Beijing (CN); Guohua JI, Beijing (CN); Zi TIAN, Beijing (CN); Ran LU, Beijing (CN); Xi CHEN, Beijing (CN)

(21) Appl. No.: 17/447,438

(22) Filed: Sep. 12, 2021

(30) Foreign Application Priority Data
Aug. 18, 2020 (CN) 202010832353.3

(51) Int. Cl. G05B 19/418; G06K 9/62

(52) U.S. Cl. CPC G05B 19/4185; G05B 19/4183; G06K 9/6256; G06K 9/6267; G06K 9/6232; G05B 19/4188

(57) ABSTRACT

Disclosed is a method and device for identifying an industry classification of an enterprise and characteristic pollutants of the enterprise, wherein the method for identifying an industry classification of an enterprise comprises: acquiring information point data of a target enterprise; determining feature words of the information point data and feature values of the feature words according to a preset semantic lexicon, preset industry summary information and the information point data; and determining the industry classification to which the target enterprise belongs according to a preset industry classification prediction model and the feature values. Through implementing the present invention, the obtained feature values can effectively avoid interference of meaningless words, such that the industry classification to which the target enterprise belongs obtained from identification is more accurate.

### CROSS REFERENCE TO RELATED APPLICATIONS

This application claims priority to Chinese Patent Application No. 202010832353.3, filed on Aug. 18, 2020, the entire contents of which are incorporated herein by reference.

### TECHNICAL FIELD

The present invention relates to the technical field of soil and groundwater pollution risk control, in particular to a method and device for identifying an industry classification of an enterprise and characteristic pollutants of an enterprise.

### BACKGROUND

Since enterprises in different industries will produce different characteristic pollutants, enterprises in different industries are managed through different measures. In order to better control the enterprises, first the industry to which the enterprise belongs needs to be judged. In the traditional method of judging the industry to which an enterprise belongs, generally the industry to which the enterprise belongs or the business scope of the enterprise recorded in the industry introduction is understood artificially, so as to artificially judge the industry to which the enterprise belongs. Although the traditional method can ensure the accuracy of identifying the industry to which the enterprise belongs, however, such kind of method needs a lot of manpower and time. Along with the application of big data technology, the industry to which the enterprise belongs can be determined using the texts in the point of information (POI) data of the enterprise acquired from the internet. However, the words which can effectively identify the industry classification to which the enterprise belongs cannot be accurately extracted from the information point data, thereby leading to errors in the industry classification to which the enterprise belongs determined through the point of information of the enterprise, and resulting in low accuracy. On the other hand, the existing text classification algorithm or model has the defects of insufficient capacity of semantic lexicon, easy overfitting, low computing speed and low efficiency, therefore, the effect in supporting the decision making of soil ecological environment management is not strong.

### SUMMARY OF THE INVENTION

Therefore, the technical problem to be solved in the present invention is to overcome the defects of existence of errors in the industry classification to which the enterprise belongs determined through the point of information of the enterprise, insufficient capacity of semantic lexicon, easy overfitting, low computing speed and low efficiency existing in the prior art, so as to provide a method and device for identifying an industry classification of an enterprise and characteristic pollutants of an enterprise.

A first aspect of the present invention provides a method for identifying an industry classification of an enterprise, including: acquiring information point data of a target enterprise; determining feature words of the information point data and feature values of the feature words according to a preset semantic lexicon, preset industry summary information and the information point data; and determining the industry classification to which the target enterprise belongs according to a preset industry classification prediction model and the feature values.

Optionally, in the method for identifying an industry classification of an enterprise provided in the present invention, the preset industry classification prediction model is determined through the following steps: acquiring enterprise training data; determining feature words of the enterprise training data and feature values of the feature words according to enterprise training data, a preset semantic lexicon, and preset industry summary information; adjusting the alpha smoothing parameters of a Gaussian Naive Bayes model according to the feature values, to obtain optimal parameters; and constructing the preset industry classification prediction model according to the optimal parameters of the Gaussian Naive Bayes model.

Optionally, in the method for identifying an industry classification of an enterprise provided in the present invention, the steps of determining the preset industry classification prediction model further include: acquiring enterprise validation data; acquiring prediction results of the industry classification to which the enterprise validation data belongs according to the preset industry classification prediction model; calculating the accuracy rate, the recall rate and the F1 value of the preset industry classification prediction model according to the prediction results; judging whether the preset industry classification prediction model satisfies preset conditions according to the accuracy rate, the recall rate and the F1 value; and if the preset industry classification prediction model does not satisfy the preset conditions, returning to the step of acquiring training data of polluting enterprises and retraining the preset industry classification prediction model.

Optionally, in the method for identifying an industry classification of an enterprise provided in the present invention, the steps of determining feature words of the information point data and feature values of the feature words according to a preset semantic lexicon, preset industry summary information and the information point data include: pre-processing the information point data to extract a plurality of words in the information point data; determining the words, existing in the preset semantic lexicon, in the plurality of words as feature words of the information point data; calculating the word frequency of the feature words according to the feature words and the preset semantic lexicon; if the feature word matches the preset industry summary information, calculating the feature value of the feature word according to the word frequency and the preset weight; and if the feature word does not match the preset industry summary information, determining the feature value of the feature word according to the word frequency.

Optionally, in the method for identifying an industry classification of an enterprise provided in the present invention, the preset semantic lexicon includes a plurality of enterprise names and feature words corresponding to the enterprise names, and the steps of calculating the word frequency of the feature words according to the feature words and the preset semantic lexicon include: calculating a forward word frequency of the feature word according to the number of the feature words in the information point data and the total number of all the feature words in the information point data; calculating the inverse text frequency of the feature word according to the total number of enterprise names in the preset semantic lexicon and the number of enterprise names containing the feature word in the preset semantic lexicon; and calculating the word frequency of the feature word according to the forward word frequency and the inverse text frequency of the feature word.

Optionally, in the method for identifying an industry classification of an enterprise provided in the present invention, the preset semantic lexicon includes enterprise semantic lexicon, and the enterprise semantic lexicon is acquired through the following steps: acquiring enterprise data, wherein the enterprise data contains the enterprise name of each enterprise and information about the industry category and business scope corresponding to each enterprise; classifying the enterprise data according to the industry category of each enterprise in the enterprise data and classification descriptions of industry classification in the national economic industry classification data; pre-processing the enterprise data to extract the words in the enterprise data; building an initial enterprise semantic lexicon according to the words in each of the words whose number of occurrences is less than a first preset threshold, and words whose number of occurrences is greater than the first preset threshold and which are meaningful for industry classification prediction; calculating the word frequencies of the words, located in the initial enterprise semantic lexicon, in the enterprise data in the initial enterprise semantic lexicon, respectively; and building the enterprise semantic lexicon according to words whose word frequency is less than a second preset threshold, and words whose word frequency is greater than the second preset threshold and which are meaningful for industry classification predictions.

Optionally, in the method for identifying an industry classification of an enterprise provided in the present invention, the industry classification to which the target enterprise belongs determined according to a preset industry classification prediction model and the feature values is medium industry, the preset semantic lexicon includes an industry semantic lexicon, and the industry semantic lexicon is acquired through the following steps: acquiring national economic industry classification data, wherein the national economic industry classification data contains industry names of small industries of national economy, industry names of medium industries and classification descriptions of each industry; pre-processing the national economic industry classification data to extract the words in the national economic industry classification data; and building an industry semantic lexicon according to the words whose number of occurrences is less than a third preset threshold in the national economic industry classification data, and words whose number of occurrences is greater than the third preset threshold and which are meaningful for industry classification prediction.

Optionally, in the method for identifying an industry classification of an enterprise provided in the present invention, the preset industry summary information is acquired through the following steps: calculating the word frequencies of the words, located in the industry semantic lexicon, in the industry names of small industries and classification descriptions of the national economic industry classification data in the industry semantic lexicon, respectively; determining the words corresponding to word frequencies greater than a fourth preset threshold in each small industry to be hot words for the small industry; and aggregating the hot words in each small industry to the medium industry to which the hot words belong according to a preset self-association table, to form the preset industry summary information.

A second aspect of the present invention provides a method for identifying classification of characteristic pollutants of an enterprise, including: acquiring information point data of a target enterprise; determining the industry classification to which the target enterprise belongs according to the information point data and the method for identifying an industry classification of the enterprise provided in the first aspect of the present invention; and determining characteristic pollutants of the target enterprise according to the industry classification to which the target enterprise belongs.

Optionally, in the method for identifying classification of characteristic pollutants of an enterprise provided in the present invention, the steps of determining characteristic pollutants of the target enterprise according to the industry classification to which the target enterprise belongs include: acquiring characteristic pollutant data, wherein the characteristic pollutant data contains the characteristic pollutants corresponding to each industry classification; and determining the characteristic pollutants of the target enterprise according to the industry classification to which the target enterprise belongs and the characteristic pollutant data.

A third aspect of the present invention provides a device for identifying an industry classification of an enterprise, including: a first data acquisition module, configured to acquire information point data of a target enterprise; a feature value calculating module, configured to determine feature words of the information point data and feature values of the feature words according to a preset semantic lexicon, preset industry summary information and the information point data; and a first industry prediction module, configured to determine an industry classification to which the target enterprise belongs according to a preset industry classification prediction model and the feature values, wherein the industry classification is a classification of medium industries.

A fourth aspect of the present invention provides a device for identifying classification of characteristic pollutants of an enterprise, including: a second data acquisition module, configured to acquire information point data of a target enterprise; a second industry prediction module, configured to determine the industry classification to which the target enterprise belongs according to the information point data and the device for identifying an industry classification of an enterprise provided in the third aspect of the present invention; and a characteristic pollutant determining module, configured to determine the characteristic pollutants of the target enterprise according to the industry classification to which the target enterprise belongs.

A fifth aspect of the present invention provides a computer device, including: at least one processor; and a memory in communication connection with the at least one processor; wherein the memory stores instructions that can be executed by the at least one processor, the instructions are executed by the at least one processor, to perform the method for identifying an industry classification of an enterprise provided in the first aspect of the present invention, or to perform the method for identifying classification of characteristic pollutants of an enterprise provided in the second aspect of the present invention.

A sixth aspect of the present invention provides a computer readable storage medium, wherein the computer readable storage medium stores computer instructions, and the computer instructions are used to enable the computer to perform the method for identifying an industry classification of an enterprise provided in the first aspect of the present invention, or to perform the method for identifying classification of characteristic pollutants of an enterprise provided in the second aspect of the present invention.

The technical solutions of the present invention have the following advantages:

1. As to the method for identifying an industry classification of an enterprise provided in the present invention, when the industry classification to which the enterprise belongs is identified, first the information point data of the target enterprise is acquired, then the feature words of the information point data and the feature values of the feature words are determined according to the preset semantic lexicon and the preset industry summary information, and finally the industry classification to which the target enterprise belongs is determined according to the preset industry classification prediction model and the feature values. Since the feature value is determined according to the semantic lexicon and industry summary information, therefore, the feature values obtained in the present application can effectively avoid the interference of meaningless words, and the industry classification to which the target enterprise belongs obtained from identification is more accurate.

2. As to the method for identifying an industry classification of an enterprise provided in the present invention, when the feature value of the feature word is determined, first the word frequency of the feature word is determined according to the preset semantic lexicon, and if the feature word matches the preset industry summary information, then the feature value of the feature word is determined according to the preset weight. This is because when the feature word matches the industry summary, the feature word is an important word for identifying the industry to which the enterprise belongs, and thereby the feature value obtained by adding the weight improves the Gaussian Naive Bayes model, further improving the accuracy rate in identifying the industry classification.

3. As to the method for identifying an industry classification of an enterprise provided in the present invention, when the enterprise semantic lexicon is determined, first the semantic lexicon is filtered for the first time according to the number of occurrences of each word to obtain the initial semantic lexicon, and then the semantic lexicon is filtered for the second time according to the word frequency of each word in the initial semantic lexicon to obtain the final enterprise semantic lexicon. Since there is a large interference in identifying the industry to which the enterprise belongs by the words with a high number of occurrences and the words with a high word frequency, therefore, a more accurate identification result can be obtained by extracting the feature words used in identifying the industry to which the enterprise belongs through the acquisition of the semantic lexicon provided in the present invention.

4. As to the method for identifying an industry classification of an enterprise provided in the present invention, when the industry summary information is determined, the industry names and classification descriptions of the small industries of the national economic industry classification data are used to calculate the word frequencies of the words in the industry semantic lexicon, and then the words with word frequencies greater than a fourth threshold are determined as the hot words of the small industries, and the hot words of the small industries are aggregated to the medium industries, to form the preset industry summary information. The preset industry summary information obtained in the present invention contains words with high relevance to each medium industry, so the industry classification predicted by the feature values obtained by the preset industry summary information obtained in the present invention is more accurate.

5. As to the method for identifying classification of characteristic pollutants of an enterprise provided in the present invention, when the characteristic pollutants of the enterprise are determined, first the information point data of the target enterprise is obtained, then the industry classification to which the target enterprise belongs is determined by the method for identifying industry classification of an enterprise provided by the first aspect of the present invention, and finally characteristic pollutants of the target enterprise are determined according to the industry classification to which the target enterprise belongs. The industry classification obtained by the method for identifying the industry classification of an enterprise provided by the first aspect of the present invention is more accurate, therefore, the characteristic pollutants of the target enterprise obtained by the method for identifying the characteristic pollutants of the enterprise provided in the present invention are also more accurate.

### BRIEF DESCRIPTION OF THE DRAWINGS

In order to more clearly illustrate the technical solutions in the specific embodiments of the present invention or the prior art, the accompanying drawings that need to be used in the description of the specific embodiments or in the prior art will be briefly described below. Apparently, the accompanying drawings in the following description are some embodiments of the present invention, and other drawings can also be obtained according to these accompanying drawings without any creative effort for those skilled in the art.

FIG. 1 is a flow chart of a specific example of a method for identifying an industry classification of an enterprise in an embodiment of the present invention;

FIG. 2 is a flow chart of a specific example of constructing a preset industry classification prediction model in an embodiment of the present invention;

FIG. 3 is a schematic diagram of the influence of different alpha smoothing parameters on the accuracy rate, the recall rate, and the F1 value of a Gaussian Naive Bayes in an embodiment of the present invention;

FIG. 4 is a flow chart of another specific example of constructing a preset industry classification prediction model in an embodiment of the present invention;

FIG. 5 is a flow chart of a specific example of a method for identifying an industry classification of an enterprise in an embodiment of the present invention;

FIG. 6 is a schematic diagram of the influence of different weights on the accuracy rate, the recall rate, and the F1 value of a Gaussian Naive Bayes in an embodiment of the present invention;

FIG. 7 is a flow chart of a specific example of a method for identifying an industry classification of an enterprise in an embodiment of the present invention;

FIG. 8 is a schematic diagram of the influence of lower frequency values on the accuracy rate of industry classification in an embodiment of the present invention;

FIG. 9 is a schematic diagram of the influence of the upper frequency values on the accuracy rate of industry classification in an embodiment of the present invention;

FIG. 10 is a flow chart of a specific example of constructing an enterprise semantic lexicon in an embodiment of the present invention;

FIG. 11 is a flow chart of a specific example of constructing an industry semantic lexicon in an embodiment of the present invention;

FIG. 12 is a flow chart of a specific example of constructing preset industry summary information in an embodiment of the present invention;

FIG. 13 is flow charts of a specific example of a method for identifying classification of characteristic pollutants of an enterprise in an embodiment of the present invention;

FIG. 14 is flow charts of a specific example of a method for identifying classification of characteristic pollutants of an enterprise in an embodiment of the present invention;

FIG. 15 is a functional block diagram of a specific example of a device for identifying an industry classification of an enterprise in an embodiment of the present invention;

FIG. 16 is a functional block diagram of a specific example of device for identifying classification of characteristic pollutants of an enterprise in an embodiment of the present invention;

FIG. 17 is a functional block diagram of a specific example of a computer device provided in an embodiment of the present invention.

### DETAILED DESCRIPTION OF THE EMBODIMENTS

The technical solutions of the present invention will be clearly and completely described below in combination with the accompanying drawings, and obviously, the described embodiments are merely a part, but not all, of the embodiments of the present invention. Based on the embodiments in the present invention, all the other embodiments obtained by those skilled in the art without any creative effort shall all fall within the protection scope of the present invention.

In the description of the present invention, it should be noted that the terms “first” and “second” are merely used for descriptive purposes, and should not be understood as indicating or implying relative importance.

Furthermore, the technical features involved in different embodiments of the present invention described below can be combined with each other as long as they do not constitute a conflict.

### Embodiment 1

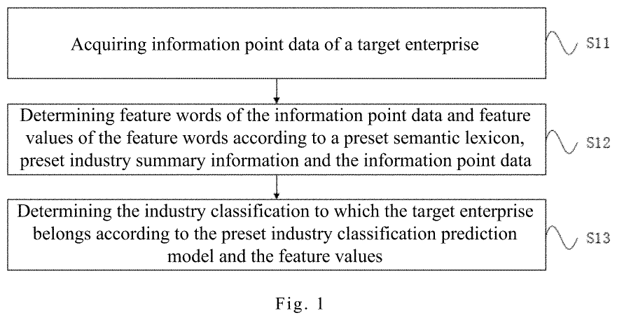

The present embodiment of the invention provides a method for identifying an industry classification of an enterprise, and as shown in FIG. 1, the method includes:

step S11: acquiring information point data of a target enterprise.

In the embodiment of the present invention, the information point data of the target enterprise includes the enterprise name of the target enterprise, i.e., as to the method for identifying the industry classification of the enterprise provided in the embodiment of the present invention, the industry classification to which the target enterprise belongs can be identified by the enterprise name of the target enterprise.

In a specific embodiment, after the information point data of the target enterprise is acquired, the information point data needs to be pre-processed first, and then Chinese word segmentation is performed. In the embodiment of the present invention, the pre-processing of the point of information includes: words such as punctuation marks, English letters, numbers and the like in the information point data are eliminated; the word segmentation of the information point data of the target enterprise is realized by using Hidden Markov Model, Viterbi algorithm and jieba word segmentation engine; and after the word segmentation, all the words that have appeared are extracted by the cut function.

Step S12: determining feature words of the information point data and feature values of the feature words according to a preset semantic lexicon, preset industry summary information and the information point data.

In the embodiment of the present invention, the preset semantic lexicon is refined according to a large amount of enterprise data, the preset semantic lexicon contains words that facilitate the determination of industry classification, the preset industry summary information is extracted according to the industry name and classification description information of each small industry, and the preset industry summary information contains typical words in each medium industry.

Step S13: determining the industry classification to which the target enterprise belongs according to the preset industry classification prediction model and the feature values. In a specific embodiment, the industry classification may be a classification of medium industry, and the industry classification may specifically include 36 medium industries such as metal processing machinery manufacturing, electronic and electrical machinery special equipment manufacturing, structural metal product manufacturing, metal surface treatment and heat treatment processing, ferroalloy smelting, special chemical product manufacturing, commonly used non-ferrous metal smelting, basic chemical raw material manufacturing, and pesticide manufacturing.

In a specific embodiment, the preset industry classification prediction model can be one of Gaussian Naive Bayes model, Random Forest model, XGBoost, etc. However, after validation, the changes in the accuracy rate, the recall rate and the F1 value caused by Random Forest, XGBoost, Naive Bayes and other industry classification algorithms are shown in Table 1 below. The accuracy rate is used to measure the accuracy of the algorithm classification results, the recall rate is used to measure the completeness of the algorithm classification results, while the F1 value is the harmonic mean of the accuracy rate and the recall rate, and the F1 value considers comprehensively the accuracy and completeness to measure the effectiveness of the algorithm classification results. As can be seen from Table 1, the classification performances of different algorithms differ to a certain extent in terms of the accuracy rate, recall rate, or F1 value, and the performance of the Gaussian Naive Bayes algorithm is superior to that of the Random Forest algorithm and XGBoost algorithm, and the former is increased by 0.07 and 0.04 respectively compared with the latter in terms of the accuracy, increased by 0.08 and 0.07 respectively in terms of the recall rate, and increased by 0.07 and 0.05 respectively in terms of the F1 value. Therefore, in the embodiment of the present invention, the Naive Bayes algorithm is used for industry classification prediction.

TABLE 1

| Algorithm category | Accuracy rate (P) | Recall rate (R) | F1 |
|---|---|---|---|
| Random Forest | 0.28 | 0.28 | 0.28 |
| XGBoost | 0.31 | 0.29 | 0.30 |
| Naive Bayes | 0.35 | 0.36 | 0.35 |

As to the method for identifying an industry classification of an enterprise provided in the present invention, when the industry classification to which the enterprise belongs is identified, first the information point data of the target enterprise is acquired, then the feature words of the information point data and the feature values of the feature words are determined according to the preset semantic lexicon and the preset industry summary information, and finally the industry classification to which the target enterprise belongs is determined according to the preset industry classification prediction model and the feature values. Since the feature value is determined according to the semantic lexicon and industry summary information, therefore, the feature values obtained in the present application can effectively avoid the interference of meaningless words and the industry classification to which the target enterprise belongs obtained from identification is more accurate.

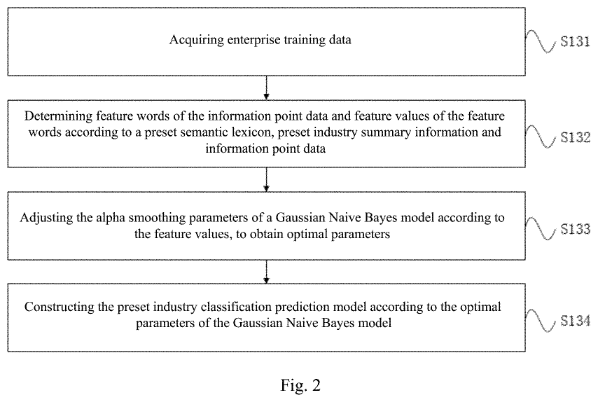

In an optional embodiment, as shown in FIG. 2, the preset industry classification prediction model used in the identification process of the method for identifying an industry classification of an enterprise provided in an embodiment of the present invention can be determined through the following steps:

step S131: acquiring enterprise training data.

In the embodiment of the present invention, the enterprise training data contains a large number of enterprise names and information about the industry business scope and industry category corresponding to the enterprises.

In a specific embodiment, after acquiring the enterprise training data, the enterprise training data also needs to be pre-processed, including: performing standardized classification on the enterprise training data according to the medium industry standard in the national economic industry classification, de-duplicating, filling and normalizing the enterprise name and business scope in the enterprise training data, and eliminating such words as punctuations, English letters, numbers, etc.; performing noise reduction through the pynlpir auxiliary function; and performing Chinese word segmentation on the enterprise training data, to obtain a plurality of words. Since the classification standards of the industry category contained in the enterprise training data may be different from the required classification standards, therefore, standardized classification needs to be performed on the enterprise training data according to the medium industry standards in the national economic industry classification.

Step S132: determining feature words of the enterprise training data and feature values of the feature words according to enterprise training data, a preset semantic lexicon, and preset industry summary information.

In a specific embodiment, a large number of words can be obtained from the enterprise training data, but not all of the words have a positive effect on industry identification, so the feature words need to be extracted first according to the preset semantic lexicon, moreover, in order to make the industry identification results more accurate, the feature value of each feature word needs to be determined according to the preset industry summary information. The preset industry summary information includes words related to different industries extracted through a large number of different industries and classification descriptions.

Step S133: adjusting the alpha smoothing parameters of a Gaussian Naive Bayes model according to the feature values, to obtain optimal parameters.

In the embodiment of the present invention, the alpha smoothing parameter is adjusted using a grid search method based on 10-fold cross-validation, and the highest value of average accuracy of the five validation sets is taken as the optimal parameter.

Since all the feature words cannot be enumerated by the preset semantic lexicon, therefore, the features of new words are still lost when the information point data is vectorized, thereby leading to an overfitting phenomenon. In addition, when a priori probability is calculated, if a feature word of the information point data has no feature value in an industry category in the training dataset, the phenomenon of zero probability will occur. Accordingly, the overfitting and zero-probability phenomenon can be mitigated by using the alpha smoothing parameter when the posterior probability is calculated, and the specific formula is as follows:

$$P ( {x}_{1} , {x}_{2} , … , {x}_{n} \vert c ) = \frac{{N}_{c} + α}{N + α \cdot n}$$

wherein, α is the alpha smoothing parameter, n refers to the number of feature words; c refers to a certain industry category, x₁ refers to the feature value of the i-th feature word, i=1, n, P(x₁, x₂, . . . , xₙ|c) means that the sample feature value is the probability of x₁, x₂, . . . , xₙ when the industry category of a certain sample is known to be c; and N refers to the number of the samples with the feature values being x₁, x₂, . . . , xₙ in the whole samples, and N_{c} refers to the number of the samples with the feature values being x₁, x₂, . . . , xₙ in the industry category c.

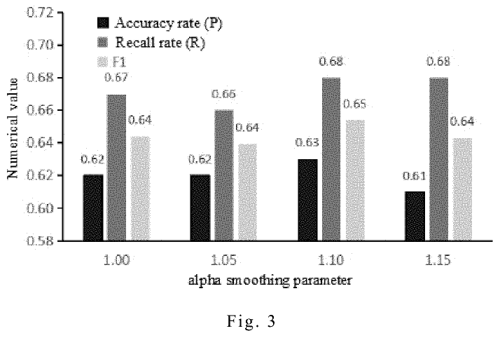

As shown in FIG. 3, different alpha smoothing parameters may cause changes in the accuracy rate, the recall rate and the F1 value of the Gaussian Naive Bayes algorithm. From FIG. 3, it can be seen that the accuracy rate, the recall rate and the F1 value do not change much when the alpha smoothing parameter is between 1.10 and 1.15, and are between 0.61-0.63, 0.66-0.68, 0.64-0.65, respectively, and the identification result is the best when the alpha smoothing parameter is 1.10.

Step S134: constructing the preset industry classification prediction model according to the optimal parameters of the Gaussian Naive Bayes model.

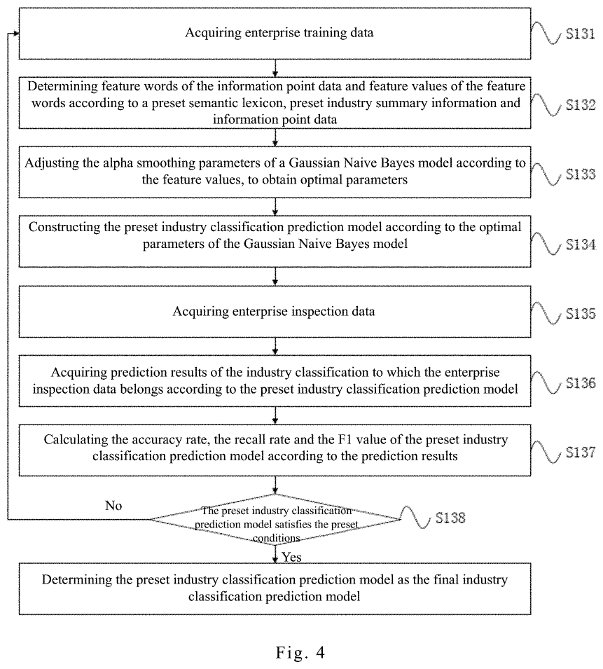

In an optional embodiment, as shown in FIG. 4, in the method for identifying an industry classification of an enterprise provided in the embodiment of the present invention, the step of determining the preset industry classification prediction model further includes:

Step S135: acquiring enterprise validation data. In the embodiment of the present invention, the proportion of the enterprise training data to the enterprise validation data can be 9:1, and can also be 8:2, and the specific proportion can be adjusted according to actual requirements. For the description of the enterprise validation data and the processing process of the enterprise validation data, please refer to the above step S131.

Step S136: acquiring prediction results of the industry classification to which the enterprise validation data belongs according to the preset industry classification prediction model.

Step S137: calculating the accuracy rate, the recall rate and the F1 value of the preset industry classification prediction model according to the prediction results.

In a specific embodiment, the accuracy rate of the preset industry classification prediction model is calculated according to the following formula:

$$P = \frac{{n}_{c}}{n}$$

Wherein, P is the accuracy rate, and represents the proportion of correctly predicted samples in all the samples; n is the number of all the samples; and is the number of correctly predicted samples.

The recall rate of the preset industry classification prediction model is calculated through the following formula:

$$R = \frac{{n}_{c}}{m}$$

Wherein, R is the recall rate, and represents the proportion of correctly predicted samples in all the samples of a certain industry; n, is the number of the correctly predicted samples; and m is the number of all the samples in a certain industry.

The F1 value of the preset industry classification prediction model is calculated through the following formula:

$$F 1 = \frac{P \cdot R \cdot 2}{P + R}$$

wherein, P is the accuracy rate, and R is the recall rate.

Step S138: judging whether the preset industry classification prediction model satisfies preset conditions according to the accuracy rate, the recall rate and the F1 value, if the preset industry classification prediction model does not satisfy preset conditions, returning to the above step S131, and retraining the preset industry classification prediction model.

In a specific embodiment, the preset conditions can be set according to the actual needs, for example, a threshold can be set for the accuracy rate, the recall rate and the F1 value, respectively, and when the accuracy rate, the recall rate and the F1 value are all greater than or equal to their respective thresholds, it means that the preset industry classification prediction model meets the preset conditions, and when one of the accuracy rate, the recall rate and the F1 value is less than its corresponding threshold, it means that the preset industry classification prediction model does not satisfy the preset conditions.

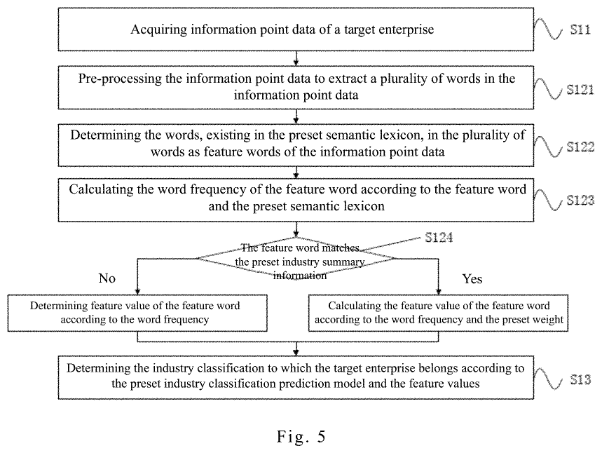

In an optional embodiment, as shown in FIG. 5, the above step S12 specifically includes:

Step S121: pre-processing the information point data to extract a plurality of words in the information point data, wherein for the pre-processing process of the information point data, please refer to the above step S11.

Step S122: determining the words, existing in the preset semantic lexicon, in the plurality of words as feature words of the information point data, wherein since the words in the preset semantic lexicon are words related with each industry classification, therefore, when the words in the preset semantic lexicon are determined to be feature words, the industry classification results can be acquired rapidly and accurately.

Step S123: calculating the word frequency of the feature word according to the feature word and the preset semantic lexicon.

Step S124: respectively judging whether each feature word matches the preset industry summary information, if so, then calculating the feature value of the feature word according to the word frequency and the preset weight; if not, then determining the feature value of the feature word according to the word frequency.

In the embodiment of the present invention, if the preset industry summary information contains a certain feature value, it is determined that the feature value matches the preset industry summary information.

As to the method for identifying an industry classification of an enterprise provided in the present invention, when the feature value of the feature word is determined, first the word frequency of the feature word is determined according to the preset semantic lexicon, and if the feature word matches the preset industry summary information, then the feature value of the feature word is determined according to the preset weight, because when the feature word matches the industry summary information, it indicates that the feature word is an important word for identifying the industry to which the enterprise belongs, and is thus the feature value obtained by adding weights, thereby improving the accuracy rate in identifying the industry classification.

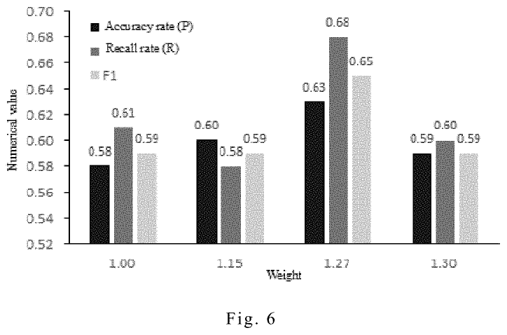

As shown in FIG. 6, different weights cause changes in the accuracy rate, the recall rate and F1 value of the Gaussian Naive Bayes algorithm. As can be seen from FIG. 6, compared with the control group (with a weight of 1), the accuracy rate, the recall rate and F1 value do not change much when the preset weights are 1.15 and 1.30, while the three values increase by 0.05, 0.07 and 0.06 respectively when the preset weight is 1.27, indicating that 1.27 is the optimal value of the preset weight. Obviously, this optimal value obviously improves the feature value of feature words with industry classification features, and avoids the phenomenon that the Gaussian Naive Bayes algorithm tends to favor large categories and ignore small categories due to uneven distribution of the number of samples in each industry in the training set, thereby improving the performance of the algorithm.

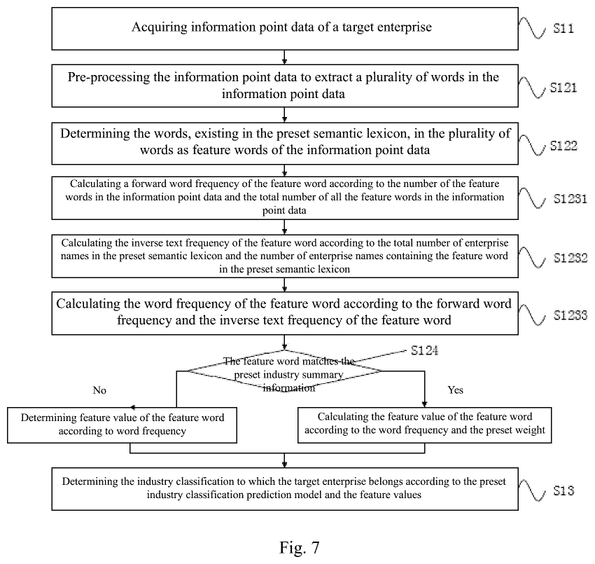

In an optional embodiment, in the method for identifying an industry classification of an enterprise provided in the present invention, the preset semantic lexicon contains a plurality of enterprise names and feature words corresponding to the enterprise names, in the above step S123, the word frequency of the feature word is calculated through the word frequency-inverse text frequency algorithm, as shown in FIG. 7, the following steps are specifically included:

Step S1231: calculating a forward word frequency of the feature word according to the number of the feature words in the information point data and the total number of all the feature words in the information point data:

$${tf}_{i , j} = \frac{{n}_{i , j}}{{\sum }_{k} {n}_{i , j}}$$

Wherein, n_{i,j} represents the number of the i-th feature word in the information point data; and Σₖⁿ^{_{i,j}} represents the total number of all the feature words in the information point data.

step S1232: calculating the inverse text frequency of the feature word according to the total number of enterprise names in the preset semantic lexicon and the number of enterprise names containing the feature word in the preset semantic lexicon:

$${idf}_{j} = log \frac{\vert D \vert}{\vert \{ j : i ∈ {d}_{j} \} \vert} ,$$

Wherein, |D| represents the total number of enterprise names in the preset semantic lexicon; dⱼ represents the j-th enterprise name; and |{j:i∈dⱼ} represents the number of the enterprise names containing the i-th feature word.

step S1233: calculating the word frequency of the feature word according to the forward word frequency and the inverse text frequency of the feature word:

tfᵢdf_{i,j}=tf_{i,j}·idf_{i,j}

Wherein, tf_{i,j} represents the forward word frequency of the i-th feature word in the j-th the enterprise; idf_{i,j} represents the inverse text frequency of the i-th feature word in the j-th the enterprise.

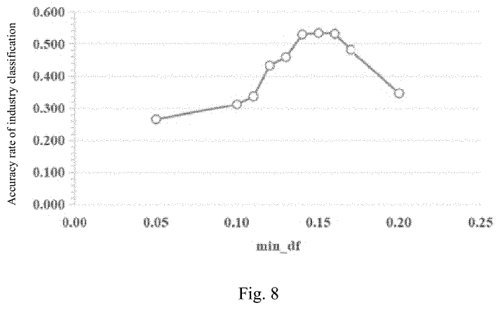

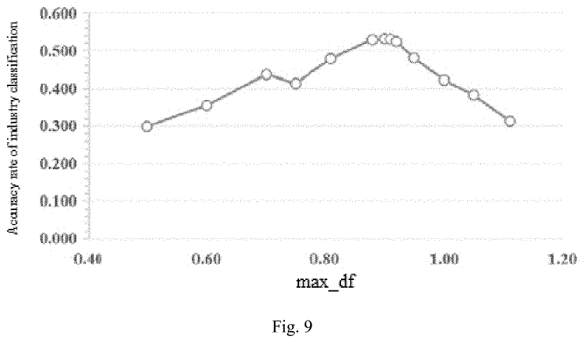

In a specific embodiment, when the word frequency is calculated by the word frequency-inverse text frequency algorithm, two parameters, that is, min_df lower frequency value and max_df upper frequency value, need to be adjusted, the lower frequency value and the upper frequency value will have an impact on the accuracy rate of industry classification. FIG. 8 shows the impact on the accuracy rate of the industry classification when the lower frequency selects different values, it can be seen from the figure that, when the lower frequency value is 0.15, the accuracy rate of industry classification is the highest, so the lower frequency value is determined as 0.15. FIG. 9 shows the impact on the accuracy rate of the industry classification when the upper frequency selects different values, it can be seen from the figure that, when the upper frequency value is 0.90, the accuracy rate of industry classification is the highest, so the upper frequency value is determined as 0.90.

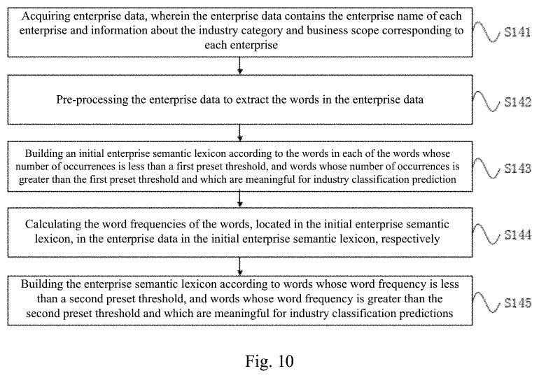

In an optional embodiment, the preset semantic lexicon includes an enterprise semantic lexicon, as shown in FIG. 10, in the method for identifying an industry classification provided in the embodiment of the present invention, the enterprise semantic lexicon can be acquired through the following steps:

Step S141: acquiring enterprise data, wherein the enterprise data contains the enterprise name of each enterprise and information about the industry category and business scope corresponding to each enterprise.

Step S142: pre-processing the enterprise data to extract the words in the enterprise data, wherein for the detailed description of pre-processing the enterprise data to extract the words in the enterprise data, please refer to the above step S131.

Step S143: building an initial enterprise semantic lexicon according to the words in each of the words whose number of occurrences is less than a first preset threshold, and words whose number of occurrences is greater than the first preset threshold and which are meaningful for industry classification prediction, wherein the first preset threshold can be adjusted according to actual conditions, for example, the number of occurrences of words can be sorted in an order from largest to smallest, the 100th number of occurrence is determined to be the first preset threshold, and an initial industry semantic lexicon is built according to the words with the number of occurrences being after the 100th rank and the words with the number of occurrences being before the 100th rank and which are meaningful for the industry classification prediction.

In a specific embodiment, there are relatively more words that are meaningful for industry classification prediction, and it is difficult to judge whether a certain word is meaningful for industry classification prediction, therefore, when a semantic lexicon is built, non-semantic words can be determined first, and the words with the number of occurrences greater than a certain threshold and meaningless for industry classification prediction are determined to be non-semantic words, and when the words appear for many times, it indicates that the noise is greater when industry classification prediction is made by the words. For example, “Ltd.” is a word that appears more often in enterprise data, and this kind of word appears in almost all the enterprise data, therefore, this kind of word can be used as a non-semantic word, and then, words such as place names can be determined as words that are meaningless for industry classification prediction. Although the number of occurrences of this type of word is not very large, however, it is not possible to determine the industry classification by this type of word. After the non-semantic words are eliminated, the remaining words are determined as semantic words, thereby forming a semantic lexicon.

Step S144: calculating the word frequencies of the words, located in the initial enterprise semantic lexicon, in the enterprise data in the initial enterprise semantic lexicon, respectively. As to the calculating method of the word frequency, please refer to the above step S1231 to step S1233.

Step S145: building the enterprise semantic lexicon according to words whose word frequency is less than a second preset threshold, and words whose word frequency is greater than the second preset threshold and which are meaningful for industry classification predictions. The second preset threshold can be adjusted according to actual conditions, for example, the word frequencies can be sorted in an order from largest to smallest, the 100^{th} word frequency is determined to be the second preset threshold, and a semantic lexicon is built according to the words with the word frequency being after the 100th rank and the words with the word frequency being before the 100th rank and which are meaningful for the industry classification prediction. Similar to the above initial enterprise semantic lexicon, the non-semantic lexicon may be determined first, and then the enterprise semantic lexicon is built through eliminating non-semantic words.

In the embodiment of the present invention, when the enterprise semantic lexicon is built, the used data is the enterprise data containing the enterprise name and the business scope corresponding to the enterprise name, and in a specific embodiment, the enterprise semantic lexicon can also be built using only the enterprise name, and for the changes of the accuracy rate, the recall rate and the F1 value of the Gaussian Naive Bayes algorithm caused by the two constructing methods, please refer to Table 2 below. It can be seen from Table 2 that, compared with the case in which only the enterprise name is adopted, after the enterprise name and business scope are adopted to construct a semantic lexicon, the accuracy rate, the recall rate and the F1 value of the Gaussian Naive Bayes algorithm are significantly improved by 0.23, 0.23 and 0.23, respectively, which results from the fact that the business scope expands the capacity of the semantic lexicon and reduces the loss of new word features when the enterprise information point data is vectorized. Therefore, in the embodiment of the present invention, the enterprise semantic lexicon constructed by using enterprise name and business scope effectively overcomes the defects of insufficient capacity caused by constructing the lexicon using only enterprise name, which further improves the accuracy rate in identifying industry classification.

TABLE 2

| Method for constructing | | | |
|---|---|---|---|
| semantic lexicon | Accuracy rate (P) | Recall rate (R) | F1 |
| Enterprise | 0.35 | 0.38 | 0.36 |
| name + business scope | 0.58 | 0.61 | 0.59 |

As to the method for identifying an industry classification of an enterprise provided in the present invention, when the enterprise semantic lexicon is determined, first the semantic lexicon is filtered for the first time according to the number of occurrences of each word to obtain the initial semantic lexicon, and then the semantic lexicon is filtered for the second time according to the word frequency of each word in the initial semantic lexicon to obtain the final enterprise semantic lexicon. Since there is a large interference in identifying the industry to which the enterprise belongs by the words with a high number of occurrences and the words with a high word frequency, therefore, a more accurate identification result can be obtained by extracting the feature words used in identifying the industry to which the enterprise belongs through the acquisition of the semantic lexicon provided in the present invention.

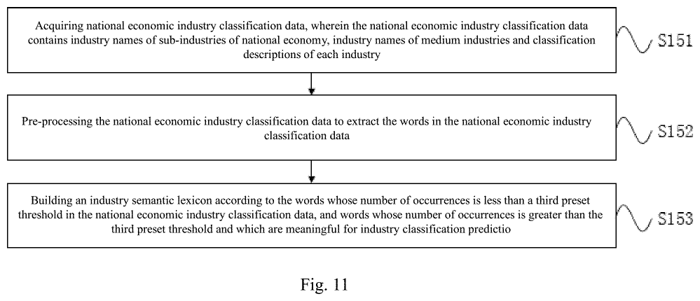

In an optional embodiment, in the method for identifying an industry classification of an enterprise provided in the embodiment of the present invention, the preset semantic lexicon includes an industry semantic lexicon, as shown in FIG. 11, in the method for identifying an industry classification provided in the embodiment of the present invention, the industry semantic lexicon is acquired through the following steps:

Step S151: acquiring national economic industry classification data, wherein the national economic industry classification data contains industry names of small industries of national economy, industry names of medium industries and classification descriptions of each industry.

Step S152: pre-processing the national economic industry classification data to extract the words in the national economic industry classification data.

The pre-processing of national economic industry classification data includes: eliminating punctuation, English letters, numbers and other words in industry names and descriptions; performing noise reduction of Chinese words through the pynlpir auxiliary function; using the preset autocorrelation table to auto-correlate the names of small classifications and their classification descriptions, and aggregating the small classifications upwards to the medium classification to which they belong, as shown in the following Table 3 which is a schematic preset autocorrelation table:

TABLE 3

| id (id of | | | P_id (id |
|---|---|---|---|
| the current | Name (category | Des (category | of parent |
| category) | name) | description) | class) |
| A | Agriculture, | This classification | 0 |
| | forestry, animal | includes 01-05 big | |
| | husbandry, fishery | classifications | |
| 1 | Agriculture | Referring to | A |
| | | planting of | |
| | | various crops | |

Step S153: building an industry semantic lexicon according to the words whose number of occurrences is less than a third preset threshold in the national economic industry classification data, and words whose number of occurrences is greater than the third preset threshold and which are meaningful for industry classification prediction. The third preset threshold can be adjusted according to actual conditions, for example, the number of occurrences of words can be sorted in an order from largest to smallest, the 100th number of occurrence is determined to be the third preset threshold, and an industry semantic lexicon is built according to the words with the number of occurrences being after the 100th rank and the words with the number of occurrences being before the 100th rank and which are meaningful for the industry classification prediction.

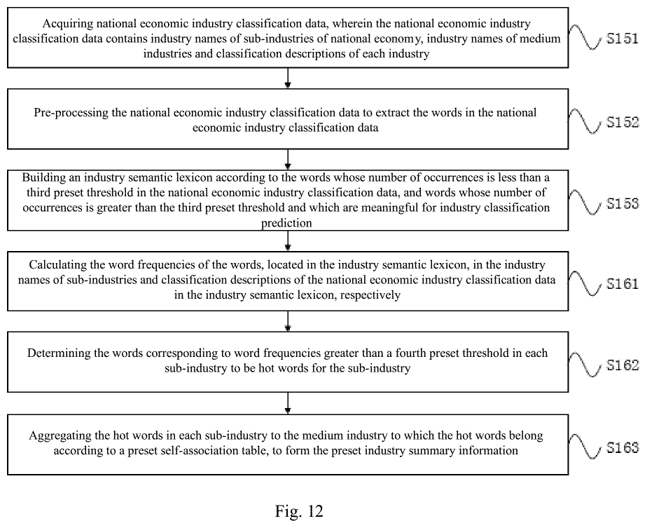

In an optional embodiment, as shown in FIG. 12, in the method for identifying an industry classification of an enterprise provided in an embodiment of the present invention, preset industry summary information can be acquired through the following steps:

Step S161: calculating the word frequencies of the words, located in the industry semantic lexicon, in the industry names of small industries and classification descriptions of the national economic industry classification data in the industry semantic lexicon, respectively. For the calculating method of word frequencies, please refer to the above step S1231 to step S1233.

Step S162: determining the words corresponding to word frequencies greater than a fourth preset threshold in each small industry to be hot words for the small industry. In a specific embodiment, the fourth preset threshold can be adjusted according to actual conditions, for example, the word frequencies can be sorted in an order from largest to smallest, the 100th word frequency is determined to be the fourth preset threshold, and the words with the word frequency ranking before 100th are determined as small industry hot words.

Step S163: aggregating the hot words in each small industry to the medium industry to which the hot words belong according to a preset self-association table, to form the preset industry summary information.

As to the method for identifying an industry classification of an enterprise provided in the present invention, when the industry summary information is determined, the industry names and classification descriptions of the small industries of the national economic industry classification data is used to calculate the word frequencies of the words in the industry semantic lexicon, and then the words with word frequencies greater than the fourth threshold are determined as the hot words of the small industries, and the hot words of the small industries are aggregated to the medium industries, to form the preset industry summary information. The preset industry summary information obtained in the present invention contains words with high relevance to each medium industry, so the industry classification predicted by the feature values obtained by the preset industry summary information obtained in the present invention is more accurate.

In the method for identifying an industry classification of an enterprise provided in the embodiment of the present invention, the industry semantic lexicon in the preset semantic lexicon and the industry summary information are established with the classification standard of the medium industries in the national economic industry classification data, therefore, the medium industry category to which the target enterprise belongs can be identified by implementing the present invention, compared with the defect that only the large industry category can be recognized in the prior art, more refined identification of industry category is realized through implementing the present invention, moreover, when the industry classification is identified through the embodiment of the present invention, the adopted feature values are determined by the preset semantic lexicon and the industry summary information, and the parameters of the preset industry classification prediction model are also optimized by the preset semantic lexicon and the industry summary information. Therefore, by implementing the embodiment of the present invention, the industry classification identification results obtained when the industry category to which the target enterprise belongs are finer and more accurate.

### Embodiment 2

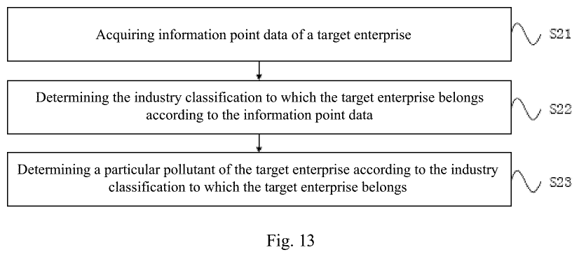

The present embodiment of the invention provides a method for identifying classification of characteristic pollutants of an enterprise, and as shown in FIG. 13, the method includes:

Step S21: acquiring information point data of a target enterprise. For detailed description, please refer to related description of step S11 of the above method embodiment.

Step S22: determining the industry classification to which the target enterprise belongs according to the information point data, wherein in the present invention, the industry classification to which the target enterprise belongs is determined according to the method for identifying an industry classification of the enterprise provided in the above embodiment 1.

Step S23: determining characteristic pollutants of the target enterprise according to the industry classification to which the target enterprise belongs.

As to the method for identifying classification of characteristic pollutants of an enterprise provided in the present invention, when the characteristic pollutants of the enterprise are determined, first the information point data of the target enterprise is obtained, then the industry classification to which the target enterprise belongs is determined by the method for identifying industry classification of an enterprise provided by the first aspect of the present invention, and finally the characteristic pollutants of the target enterprise are determined according to the industry classification to which the target enterprise belongs. The industry classification obtained by the method for identifying the industry classification of an enterprise provided by the first aspect of the present invention is more accurate, therefore, the characteristic pollutant of the target enterprise obtained by the method for identifying the characteristic pollutants of the enterprise provided in the present invention is also more accurate.

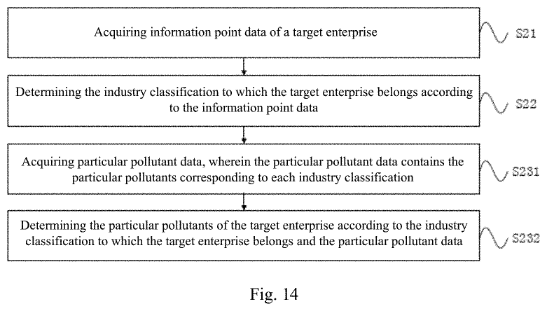

In an optional embodiment, as shown in FIG. 14, the above step S23 specifically includes:

Step S231: acquiring characteristic pollutant data, wherein the characteristic pollutant data contains the characteristic pollutants corresponding to each industry classification.

Step S232: determining the characteristic pollutants of the target enterprise according to the industry classification to which the target enterprise belongs and the characteristic pollutant data.

In a specific embodiment, a database table can be established according to the characteristic pollutant data, and different industry classifications and their corresponding characteristic pollutants are correspondingly stored in the database table, and when the industry classification to which the target enterprise belongs is acquired through the above Embodiment 1, the characteristic pollutants corresponding to the industry classification can be directly obtained through the database table, and the characteristic pollutants are identified as the characteristic pollutants of the target enterprise.

### Embodiment 3

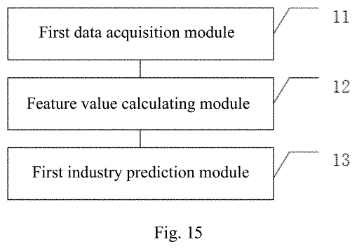

The present embodiment of the invention provides a device for identifying an industry classification of an enterprise, and as shown in FIG. 15, the device includes:

a first data acquisition module 11, configured to acquire information point data of a target enterprise, and for detailed description, please refer to the description of step S11 in the above embodiment 1,

a feature value calculating module 12, configured to determine feature words of the information point data and feature values of the feature words according to a preset semantic lexicon, preset industry summary information and the information point data, and for detailed description, please refer to the description of step S12 in the above embodiment 1, and

a first industry prediction module 13, configured to determine an industry classification to which the target enterprise belongs according to a preset industry classification prediction model and the feature values, wherein the industry classification is a classification of medium industries, and for detailed description, please refer to the description of step S13 in the above embodiment 1.

As to the device for identifying an industry classification of an enterprise provided in the present invention, when the industry classification to which the enterprise belongs is identified, first the information point data of the target enterprise is obtained, then the feature words of the information point data and the feature values of the feature words are determined according to the preset semantic lexicon and the preset industry summary information, and finally the industry classification to which the target enterprise belongs is determined according to the preset industry classification prediction model and the feature values. Since the feature value is determined according to the semantic lexicon and the industry summary information, therefore, the feature value obtained in the present application can effectively avoid the interference of meaningless words and the identified industry classification to which the target enterprise belongs can be more accurate.

### Embodiment 4

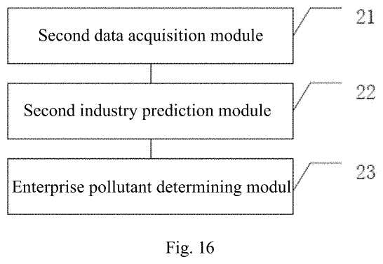

The embodiment of the present invention provides a device for identifying classification of characteristic pollutants of an enterprise, and as shown in FIG. 16, the device includes:

a second data acquisition module 21, configured to acquire information point data of a target enterprise, wherein for detailed description, please refer to the description of step S21 in the above embodiment 2,

a second industry prediction module 22, configured to determine the industry classification to which the target enterprise belongs according to the information point data and the device for identifying an industry classification of an enterprise as claimed in claim 11, wherein for detailed description, please refer to the description of step S22 in the above embodiment 2, and

an enterprise characteristic pollutant determining module 23, configured to determine the characteristic pollutants of the target enterprise according to the industry classification to which the target enterprise belongs, wherein for detailed description, please refer to the description of step S23 in the above embodiment 2.

As to the device for identifying classification of characteristic pollutants of an enterprise provided in the present invention, when the characteristic pollutants of the enterprise are determined, first the information point data of the target enterprise is obtained, then the industry classification to which the target enterprise belongs is determined by the method for identifying industry classification of an enterprise provided by the first aspect of the present invention, and finally characteristic pollutants of the target enterprise are determined according to the industry classification to which the target enterprise belongs. The industry classification obtained by the method for identifying the industry classification of an enterprise provided by the first aspect of the present invention is more accurate, therefore, the characteristic pollutants of the target enterprise obtained by the device for identifying the classification of the characteristic pollutants of the enterprise provided in the present invention are also more accurate.

### Embodiment 5

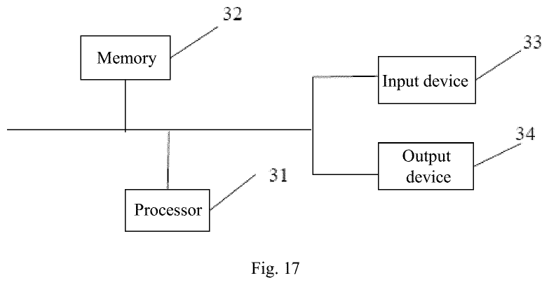

The present embodiment of the invention provides a computer device, as shown in FIG. 17, the computer device primarily includes one or a plurality of processors 31 and a memory 32, and one processor 31 is taken as an example in FIG. 17.

The computer device may also include: an input device 33 and an output device 34.

The processor 31, the memory 32, the input device 33, and the output device 34 may be connected via a bus or through other manners, and in FIG. 17, bus connection is taken as an example.

The processor 31 can be a central processing unit (CPU). The processor 31 may also be other general-purpose processors, digital signal processors (DSPs), application specific integrated circuits (ASICs), field-programmable gate arrays (FPGAs) or other programmable logic devices, discrete gates or transistor logic devices, discrete hardware components and other chips, or a combination of the above types of chips. The general-purpose processor may be a microprocessor or the processor may also be any conventional processor, etc. The memory 32 may include a memory program area and a memory data area, wherein the memory program area may store the operating system, and the application programs required for at least one function; the memory data area may store the data created by the use of the device for identifying the industry classification of an enterprise or the device for identifying the classification of characteristic pollutants of an enterprise. In addition, the memory 32 may include high-speed random access memories, and may also include non-transitory memories, such as at least one disk memory device, flash memory device, or other non-transitory solid state memory devices. In some embodiments, the memory 32 optionally includes a memory that is remotely set relative to the processor 31, and these remote memories may be connected via a network to a device for identifying the industry classification of an enterprise, or, a device for identifying the classification of characteristic pollutants of an enterprise. The input device 33 may receive a calculating request (or other numeric or character information) entered by a user, and generate a key signal input related to the device for identifying the industry classification of an enterprise or the device for identifying the classification of characteristic pollutants of an enterprise. The output device 34 may include a display device, such as a display screen, for outputting calculating results.

### Embodiment 6

The present embodiment of the invention provides a computer-readable storage medium which stores computer instructions, the computer-readable storage medium stores computer-executable instructions, the computer-executable instructions can execute the method for identifying an industry classification of an enterprise or a method for identifying the classification of characteristic pollutants of an enterprise provided in any of the above arbitrary method embodiments. Wherein the storage medium may be a diskette, an optical disk, a read-only storage memory (ROM), a random access memory (RAM), a flash memory (Flash Memory), a hard disk drive (HDD for short), or a solid-state drive (SSD), etc.; and the storage medium may also include a combination of the above-mentioned types of memories.

Obviously, the above embodiments are merely examples for clear description and are not limitations on the implementing manners. For those skilled in the art, other forms of variations or changes may be made on the basis of the above description. All the implementing manners are not necessary and cannot be enumerated herein, while the obvious variations or changes derived therefrom will still fall within the protection scope of the present invention.

What is claimed is:

1. A method for identifying an industry classification of an enterprise, comprising:
acquiring information point data of a target enterprise;
determining feature words of the information point data and feature values of the feature words according to a preset semantic lexicon, preset industry summary information and the information point data; and
determining the industry classification to which the target enterprise belongs according to a preset industry classification prediction model and the feature values.

2. The method for identifying an industry classification of an enterprise of claim 1, wherein the preset industry classification prediction model is determined through the following steps:
acquiring enterprise training data;
determining feature words of the enterprise training data and feature values of the feature words according to enterprise training data, a preset semantic lexicon, and preset industry summary information;
adjusting the alpha smoothing parameters of a Gaussian Naive Bayes model according to the feature values, to obtain optimal parameters; and
constructing the preset industry classification prediction model according to the optimal parameters of the Gaussian Naive Bayes model.

3. The method for identifying an industry classification of an enterprise of claim 2, wherein the step of determining the preset industry classification prediction model further comprises:
acquiring enterprise validation data;
acquiring prediction results of the industry classification to which the enterprise validation data belongs according to the preset industry classification prediction model;
calculating the accuracy rate, the recall rate and the F1 value of the preset industry classification prediction model according to the prediction results;
judging whether the preset industry classification prediction model satisfies preset conditions according to the accuracy rate, the recall rate and the F1 value; and
if the preset industry classification prediction model does not satisfy the preset conditions, returning to the step of acquiring training data of polluting enterprises and retraining the preset industry classification prediction model.

4. The method for identifying an industry classification of an enterprise of claim 1, wherein the step of determining feature words of the information point data and feature values of the feature words according to a preset semantic lexicon, preset industry summary information and the information point data comprises:
pre-processing the information point data to extract a plurality of words in the information point data;
determining the words, existing in the preset semantic lexicon, in the plurality of words as feature words of the information point data;
calculating the word frequency of the feature words according to the feature words and the preset semantic lexicon;
if the feature word matches the preset industry summary information, calculating the feature value of the feature word according to the word frequency and the preset weight; and
if the feature word does not match the preset industry summary information, determining the feature value of the feature word according to the word frequency.

5. The method for identifying an industry classification of an enterprise of claim 4, wherein the preset semantic lexicon comprises a plurality of enterprise names and feature words corresponding to the enterprise names,
the steps of calculating the word frequency of the feature words according to the feature words and the preset semantic lexicon comprise:
calculating a forward word frequency of the feature word according to the number of the feature words in the information point data and the total number of all the feature words in the information point data;
calculating the inverse text frequency of the feature word according to the total number of enterprise names in the preset semantic lexicon and the number of enterprise names containing the feature word in the preset semantic lexicon; and
calculating the word frequency of the feature word according to the forward word frequency and the inverse text frequency of the feature word.

6. The method for identifying an industry classification of an enterprise of claim 3, wherein the preset semantic lexicon comprises enterprise semantic lexicon, and the enterprise semantic lexicon is acquired through the following steps:
acquiring enterprise data, wherein the enterprise data contains the enterprise name of each enterprise and information about the industry category and business scope corresponding to each enterprise;
pre-processing the enterprise data to extract the words in the enterprise data;
building an initial enterprise semantic lexicon according to the words in each of the words whose number of occurrences is less than a first preset threshold, and words whose number of occurrences is greater than the first preset threshold and which are meaningful for industry classification prediction;
calculating the word frequencies of the words, located in the initial enterprise semantic lexicon, in the enterprise data in the initial enterprise semantic lexicon, respectively; and
building the enterprise semantic lexicon according to words whose word frequency is less than a second preset threshold, and words whose word frequency is greater than the second preset threshold and which are meaningful for industry classification predictions.

7. The method for identifying an industry classification of an enterprise of claim 3, wherein the industry classification to which the target enterprise belongs is determined to be medium industry according to a preset industry classification prediction model and the feature values, the preset semantic lexicon comprises an industry semantic lexicon, and the industry semantic lexicon is acquired through the following steps:
acquiring national economic industry classification data, wherein the national economic industry classification data contains industry names of small industries of national economy, industry names of medium industries and classification descriptions of each industry;
pre-processing the national economic industry classification data to extract the words in the national economic industry classification data; and
building an industry semantic lexicon according to the words whose number of occurrences is less than a third preset threshold in the national economic industry classification data, and words whose number of occurrences is greater than the third preset threshold and which are meaningful for industry classification prediction.

8. The method for identifying an industry classification of an enterprise of claim 7, wherein the preset industry summary information is acquired through the following steps:
calculating the word frequencies of the words, located in the industry semantic lexicon, in the industry names of small industries and classification descriptions of the national economic industry classification data in the industry semantic lexicon, respectively;
determining the words corresponding to word frequencies greater than a fourth preset threshold in each small industry to be hot words for the small industry; and
aggregating the hot words in each small industry to the medium industry to which the hot words belong according to a preset self-association table, to form the preset industry summary information.

9. A method for identifying classification of characteristic pollutants of an enterprise, comprising:
acquiring information point data of a target enterprise;
determining an industry classification to which the target enterprise belongs according to the information point data and the method for identifying an industry classification of the enterprise as claimed in claim 1; and
determining characteristic pollutants of the target enterprise according to the industry classification to which the target enterprise belongs.

10. The method for identifying classification of characteristic pollutants of an enterprise of claim 9, wherein the step of determining characteristic pollutants of the target enterprise according to the industry classification to which the target enterprise belongs comprises:
acquiring characteristic pollutant data, wherein the characteristic pollutant data contains the characteristic pollutants corresponding to each industry classification; and
determining the characteristic pollutants of the target enterprise according to the industry classification to which the target enterprise belongs and the characteristic pollutant data.

11. A computer device, comprising:
at least one processor; and a memory in communication connection with the at least one processor; wherein the memory stores instructions that can be executed by the at least one processor, the instructions are executed by the at least one processor, to perform the method for identifying an industry classification of an enterprise as claimed in claim 1.

12. A computer device, comprising:
at least one processor; and a memory in communication connection with the at least one processor; wherein the memory stores instructions that can be executed by the at least one processor, the instructions are executed by the at least one processor, to perform the method for identifying classification of particular pollutants of an enterprise as claimed in claim 9.

13. A computer readable storage medium, wherein the computer readable storage medium stores computer instructions, and the computer instructions are used to enable the computer, to perform the method for identifying an industry classification of an enterprise as claimed in claim 1.

14. A computer readable storage medium, wherein the computer readable storage medium stores computer instructions, and the computer instructions are used to enable the computer, to perform the method for identifying classification of particular pollutants of an enterprise as claimed in claim 9.
